(19) United States
(12) Patent Application Publication
(10) Pub. No.: US 2006/0222896 A1
(43) Pub. Date: Oct. 5, 2006

(54) Magnetic recording medium and magnetic storage apparatus

(75) Inventors: Akihiro Inomata, Kawasaki (JP); Antony Ajan, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/212,333

(22) Filed: Aug. 26, 2005

(30) Foreign Application Priority Data
Mar. 31, 2005 (JP) 2005-105239

(51) Int. Cl. G11B 5/64

(52) U.S. Cl. 428/826; 428/831.2

(57) ABSTRACT

A magnetic recording medium includes a plurality of recording cells separated from each other on a substrate in a recording direction and a track width direction perpendicular to the recording direction. The recording cell includes a recording layer. The recording layer has a magnetic easy axis inclining in a designated oblique direction against a surface of the substrate.

### BACKGROUND OF THE INVENTION

1. Field of the Invention

The present invention generally relates to magnetic recording media and magnetic storage apparatuses.

2. Description of the Related Art

A metal thin film having a recording layer made of a ferromagnetic material is used for a recording medium used for a hard disk apparatus. The metal thin film is made of a large number of ferromagnetic crystal particles of CoCrPt alloy and polycrystal made of non-magnetic grain boundary parts isolating the ferromagnetic crystal particles. As recording density is becoming high these days, it is necessary to progress in making the ferromagnetic crystal particle minute to reduce medium noise.

On the other hand, a magnetic recording medium made of plural recording cells artificially separated from each other as a recording layer is suggested. Since each of the recording cells is arranged separately, interaction among the recording cells is reduced so that the medium noise can be reduced. However, since the recording cell has information of 1 bit, it is necessary to make the recording cell minute in order to achieve high recording density.

In any cases of such a magnetic recording medium, as for making the recording cell minute, there is a problem of a phenomenon where the magnetization recorded in the recording layer is reduced with the passage of time, that is, a problem of thermal stability of the recorded magnetization (thermal fluctuation) may happen. Because of this, a method is used whereby a uniaxial anisotropic constant is increased so that thermal stability of the recorded magnetization is maintained. See Japan Laid-Open Patent Application Publications No. 05-258268 and No. 2004-220670.

Meanwhile, since anisotropic magnetic field strength is increased due to increase of the uniaxial anisotropic constant of the recording layer, the magnetization of the recording layer may not be reversed even if a magnetic field in a reverse direction is applied. Because of this, it is necessary to increase the recording magnetic field strength for reversing the magnetization of the recording layer in the magnetic head. However, it is also necessary to make a recording element of the magnetic head minute as the recording density becomes higher. Therefore, if the recording magnetic field strength is increased, a magnetic pole of the recording element is magnetically saturated so that the recording magnetic field strength cannot be increased. Because of this, a soft magnetic material having a high saturation magnetic flux density is sought as a magnetic pole material. However, such a material may not be made available. Thus, as the recording density becomes higher, recording for the magnetic recording medium and the recording element may become difficult.

In the recording magnetic field emanating from the recording element to the recording layer, the magnetic field strength distribution may be spread as the magnetic pole becomes close to a magnetically saturated situation. That is, as a recording magnetic field flowing from the recording element becomes close to the recording layer, the magnetic field strength distribution is spread and therefore it is difficult to apply the recording magnetic field to be concentrated on a narrow area of the recording layer. In this case, the recording magnetic field is applied to a track neighboring to a track to be recorded. Therefore, a problem of a side erase, namely a problem of erasing of the magnetization recorded in the neighboring track, may happen. Because of this, the S/N ratio is reduced so that there is a limitation to increasing track density. Furthermore, since the recording magnetic field in a recording direction is spread, there is a limitation to making the magnetization area corresponding to one bit formed in the track to be recorded minute. Thus, it is difficult to shorten the distance between tracks neighboring each other and the distance between bits in a track longitudinal direction.

### SUMMARY OF THE INVENTION

Accordingly, it is a general object of the present invention to provide a novel and useful magnetic recording medium and magnetic storage apparatus in which one or more of the problems described above are eliminated.

Another and more specific object of the present invention is to provide a magnetic recording medium and magnetic storage apparatus whereby a noise is reduced, good ease in recording is obtained, the side erase or self track erase is prevented, and a high recording density is obtained.

The above objects of the present invention are achieved by a magnetic recording medium, including:

a plurality of recording cells separated from each other on a substrate in a recording direction and a track width direction perpendicular to the recording direction;

wherein the recording cell includes a recording layer; and

the recording layer has a magnetic easy axis inclining in a designated oblique direction against a surface of the substrate.

According to the present invention, the magnetic recording medium includes the recording cells separated from each other in the recording direction and the track width direction. Hence, the interaction of the neighboring recording cells is reduced so that the medium noise can be prevented. The magnetic easy axis is inclined against the substrate surface. Since the magnetic easy axis is inclined, the recording layer of the recording cell that is an object for being recorded can be magnetized by a smaller recording magnetic field strength, and it is possible to obtain good ease in recording. In addition, the magnetic easy axis of the magnetic recording medium is orientated in a designated oblique planar direction. By setting the oblique planar direction to be the track width direction, it is possible to prevent the side erase. Furthermore, by setting the oblique planar direction of the magnetic easy axis to be the recording direction, it is possible to prevent the self track erase. In addition, by setting the oblique planar direction of the magnetic easy axis to be a direction between the track width direction and the recording direction, it is possible to prevent both the side erase and the self track erase. As a result of this, it is possible to provide a magnetic recording medium whereby noise is reduced, good ease in recording is obtained, the side erase and the self track erase are prevented, and a high recording density is obtained.

The above objects of the present invention are achieved by a magnetic storage apparatus, including:

a recording generation part having a magnetic head; and

a magnetic recording medium including a plurality of recording cells separated from each other on a substrate in a recording direction and a track width direction perpendicular to the recording direction;

wherein the recording cell includes a recording layer; and

the recording layer has a magnetic easy axis inclining in a designated oblique direction against a surface of the substrate.

According to the present invention, it is possible to provide a magnetic storage apparatus whereby noise is reduced, good ease in recording is obtained, the side erase and the self track erase are prevented, and a high recording density is obtained.

Other objects, features, and advantages of the present invention will become more apparent from the following detailed description when read in conjunction with the accompanying drawings.

### BRIEF DESCRIPTION OF THE DRAWINGS

FIG. 1 is a perspective basic structural view of a magnetic recording medium of a first embodiment of the present invention;

FIG. 2 is a plan view showing the magnetic recording medium shown in FIG. 1;

FIG. 3 is a schematic view showing a state where the magnetic recording medium shown in FIG. 1 is being recorded;

FIG. 4 is a graph showing a relationship between a magnetization strength H₀ necessary for the reversal of the magnetization and an angle θ_{HD} formed by a direction of a recording magnetic field Ha shown in FIG. 3 and a magnetic easy axis EA;

FIG. 5 is a plan view of another example of the magnetic recording medium of the first embodiment of the present invention;

FIG. 6 is a plan view of another example of the magnetic recording medium of the first embodiment of the present invention;

FIG. 7 is a perspective cross-sectional view of a magnetic recording medium of a first example of the first embodiment of the present invention;

FIG. 8 is a cross-sectional view of the magnetic recording medium of the first example of the first embodiment of the present invention;

FIG. 9 is a cross-sectional view of a sputtering apparatus for explaining a method for forming a base layer of the recording medium of the first example of the first embodiment of the present invention;

FIG. 10 is a cross-sectional view of a magnetic recording medium of a second example of the first embodiment of the present invention;

FIG. 11 is a cross-sectional view of a magnetic recording medium of a third example of the first embodiment of the present invention;

FIG. 12 is a cross-sectional view of a magnetic recording medium of a fourth example of the first embodiment of the present invention;

FIG. 13 is a cross-sectional view of a magnetic recording medium of a fifth example of the first embodiment of the present invention;

FIG. 14 is a cross-sectional view of a magnetic recording medium of a sixth example of the first embodiment of the present invention;

FIG. 15 is a cross-sectional view of a magnetic recording medium of a seventh example of the first embodiment of the present invention;

FIG. 16 is a cross-sectional view of a magnetic recording medium of an eighth example of the first embodiment of the present invention;

FIG. 17 is a cross-sectional view of a magnetic recording medium of a ninth example of the first embodiment of the present invention;

FIG. 18 is a cross-sectional view of a magnetic recording medium of a tenth example of the first embodiment of the present invention;

FIG. 19 is a cross-sectional view of a magnetic recording medium of an eleventh example of the first embodiment of the present invention;

FIG. 20 is a cross-sectional view of a magnetic recording medium of a twelfth example of the first embodiment of the present invention; and

FIG. 21 is a plan view showing a main part of a magnetic storage apparatus of a second embodiment of the present invention.

### DETAILED DESCRIPTION OF THE PREFERED EMBODIMENTS

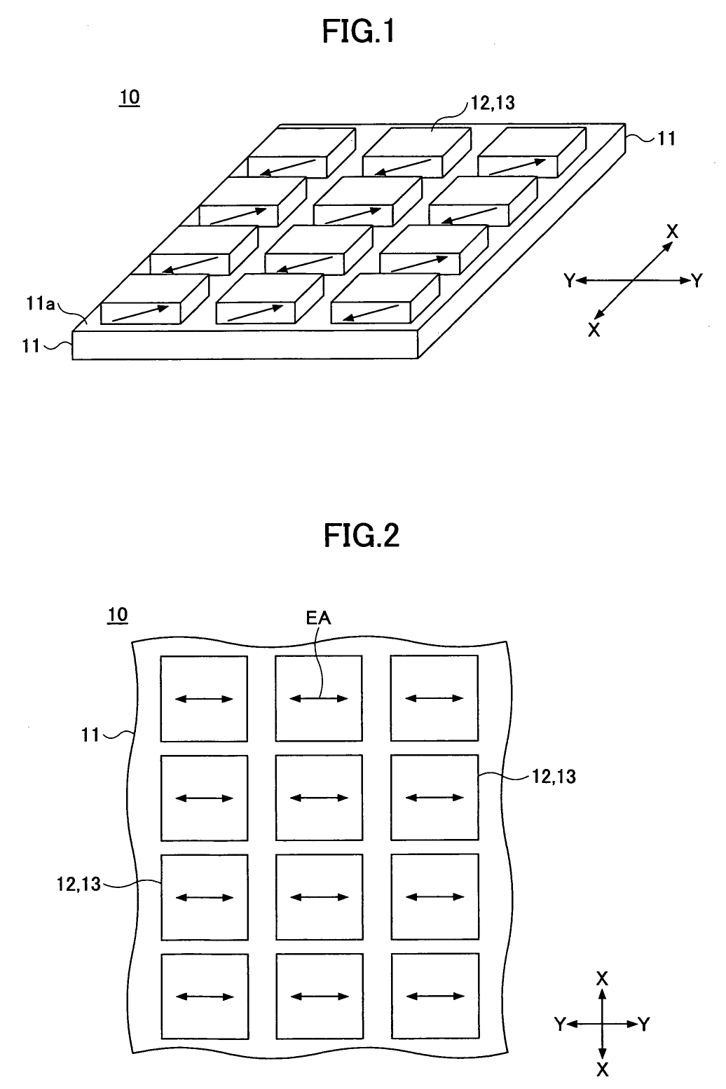

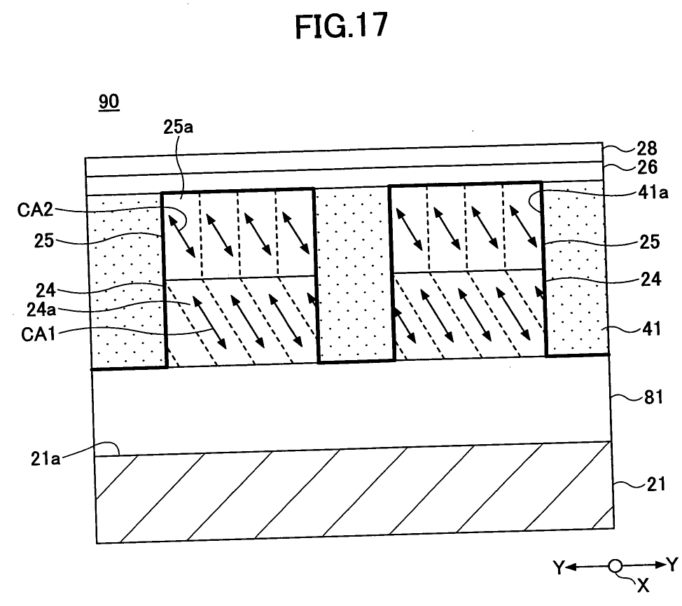

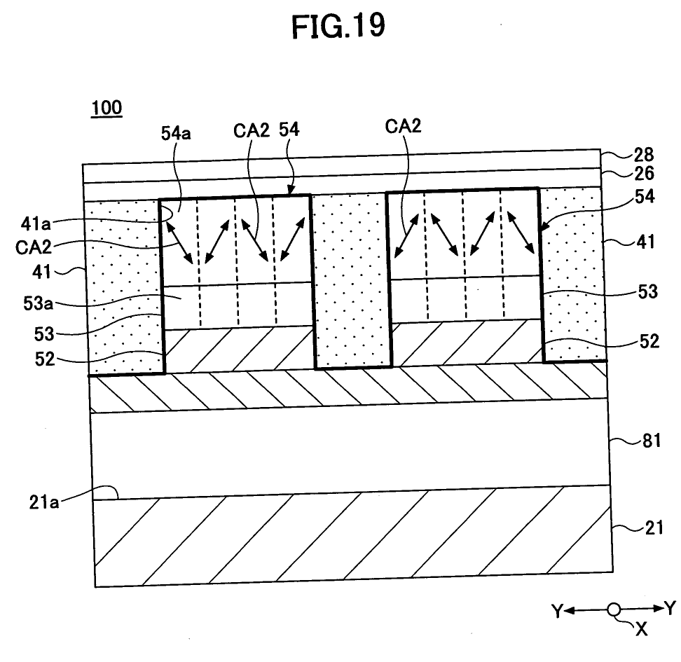

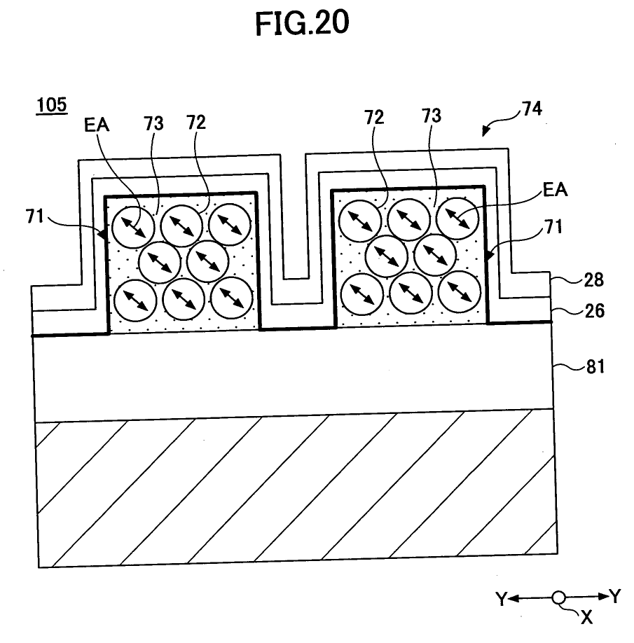

A description will now be given, with reference to FIG. 1 through FIG. 21, of embodiments of the present invention.

### First Embodiment

FIG. 1 is a perspective basic structural view of a magnetic recording medium of a first embodiment of the present invention. FIG. 2 is a plan view showing the magnetic recording medium shown in FIG. 1.

Referring to FIG. 1 and FIG. 2, in the magnetic recording medium 10 of the first embodiment, recording cells 12 are arranged on a substrate 11 with substantially constant gaps in a recording direction (in a X-axis direction). The recording cells 12 arranged in the recording direction form a single track. In addition, plural tracks are arranged with substantially constant gaps in a direction (Y-axis direction) perpendicular to the recording direction.

Recording layers 13 are provided on the recording cells 12. For the convenience of explanation, the recording cell 12 is described as being formed by only the recording layer 13. A magnetic easy axis EA of the recording layer 13 is inclined at a designated oblique angle against a substrate surface 11a. An average of the oblique angle is set to be equal to or larger than 10 degrees and equal to or less than 80 degrees. As described below, because of this setting, the writeability of the recording cell 12 which is an object for being recorded is improved. As shown in FIG. 2, an element parallel with the substrate surface 11a (planar direction) of the magnetic easy axis EA of the recording layer 13 is substantially parallel with a track width direction.

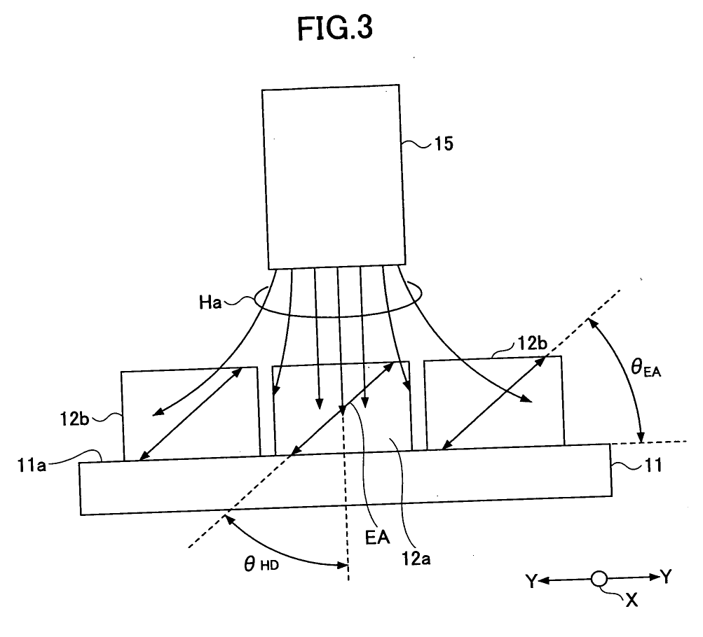

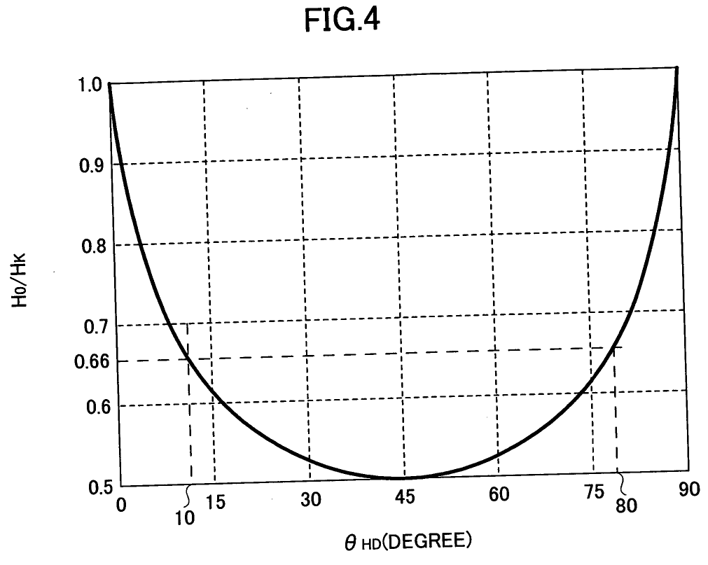

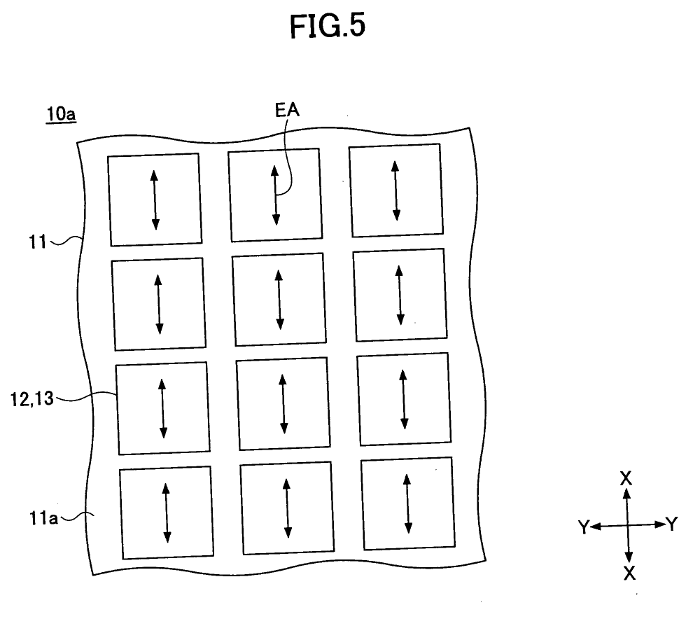

FIG. 3 is a schematic view showing a state where the magnetic recording medium 10 shown in FIG. 1 is being recorded, a cross-sectional view of the magnetic recording medium 10 being taken along the track width direction (Y-axis direction). FIG. 4 is a graph showing a relationship between magnetization strength H₀ necessary for the reversal of the magnetization of the recording layer 13 and an angle θ_{HD} formed by the direction of a recording magnetic field H1 shown in FIG. 3 and the magnetic easy axis EA. The scale values H₀/H_{K} of the vertical axis of FIG. 4 are obtained by normalizing the recording magnetic field strength H₀ necessary for the rotation of the magnetization with an anisotropic magnetic field Hₖ. The anisotropic magnetic field Hₖ is the magnetic field necessary for reversing the magnetization by applying the recording magnetic field Ha in a direction opposite to the magnetization direction in a case where the magnetization direction is parallel with the magnetic easy axis EA. A relationship shown in FIG. 4 is in accordance with the Stoner Wolfarth model.

Referring to FIG. 3 and FIG. 4, a recording magnetic field Ha is applied from a main magnetic pole 15 of a magnetic head for vertical recording to the magnetic recording medium 10. The recording magnetic field Ha is applied to a recording cell 12a situated on a track being an object for recording in a direction substantially perpendicular to the substrate surface 11a. In a case where an average oblique angle θ_{EA} formed by the magnetic easy axis EA and the substrate surface 11a is set to be between 10 degrees and 80 degrees, an angle θ_{HD} formed by the recording magnetic field Ha and the magnetic easy axis EA is between 80 degrees and 10 degrees, respectively.

As shown in FIG. 4, if the angle θ_{HD} is close to 0 degree or 90 degrees, H₀ is equivalent to Hₖ. However, if θ is 45 degrees, H₀ is 50% of Hₖ. That is, if θ is close to 0 degrees or 90 degrees, the recording magnetic field strength H₀ necessary for reversing the magnetization is equivalent to the anisotropic magnetic field Hₖ. That is, if θ is close to 45 degrees, the recording magnetic field strength H₀ is 50% of Hₖ, namely minimum. If the angle θ_{HD} is between 80 degrees and 10 degrees, the recording magnetic field strength H₀ necessary for reversing the magnetization is reduced to a range from 0.66×Hk to 0.50×Hk so that it is possible to easily reverse the magnetization. Therefore, the writeability is made good.

Referring back to FIG. 3, a recording magnetic field spread from the main magnetic pole 15 in the track width direction is applied to the recording cell 12b neighboring the recording cell 12a being an object for recording. The direction of such a recording magnetic field is close to 0 degrees or 90 degrees against the magnetic easy axis EA of the recording layer. In this case, as shown in FIG. 4, H₀ is substantially the same as H_{K}. Since it becomes difficult to reverse the magnetization due to the recording magnetic field being in this direction, the influence of the recording magnetic field Ha on the magnetization of the recording cell 12b neighboring in the track width direction is reduced. That is, the magnetic recording medium 10 can prevent the side erase.

FIG. 5 is a plan view of another example of the magnetic recording medium of the first embodiment of the present invention. Referring to FIG. 5, in the magnetic recording medium 10a, the element parallel with the substrate surface 11a (planar direction) of the magnetic easy axis EA of the recording cell 12 is oriented toward to the recording direction (X-axis direction). The magnetic easy axis EA is inclined against the substrate surface 11a as shown in FIG. 3. By forming the magnetic easy axis EA, it is possible to reduce the influence given to the magnetization of the recording cell 12 neighboring in the recording direction against the recording cell that is an object for being recorded.

The magnetic field emanating in the recording direction from the main magnetic pole is applied to the recording cells 12 neighboring in the recording direction of the recording cell that is an object to be recorded. The direction of the recording magnetic field is a direction of 0 degree or 90 degrees from the magnetic easy axis EA of the recording cell 12 as well as the case shown in FIG. 3 (inclined oblique angle), in a case where the recording magnetic field strength is large.

Therefore, since the magnetization may not be reversed due to the recording magnetic field of such a direction, the influence on the magnetization of the recording cell 12 neighboring in the recording direction may be little. That is, self track erase, wherein the magnetization formed on the neighboring recording cells is demagnetized just after recording is performed, is prevented.

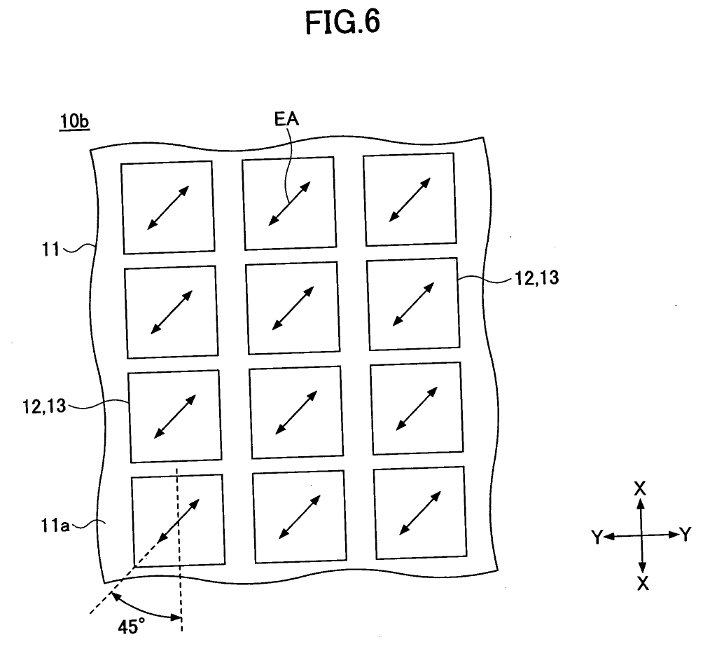

FIG. 6 is a plan view of another example of the magnetic recording medium of the first embodiment of the present invention. Referring to FIG. 6, in the magnetic recording medium 10b, the element parallel with the substrate surface 11a (planar direction) of the magnetic easy axis EA of the recording cell 12 forms an angle of 45 degrees against the recording direction so as to be orientated toward the track width direction. The magnetic easy axis EA is inclined against the substrate surface 11a as shown in FIG. 3. By forming the magnetic easy axis EA as illustrated in FIG. 6, it is possible to have the same effects as the magnetic recording media shown in FIG. 2 and FIG. 5. That is, the magnetic recording medium 10 can prevent both side erase and the self track erase.

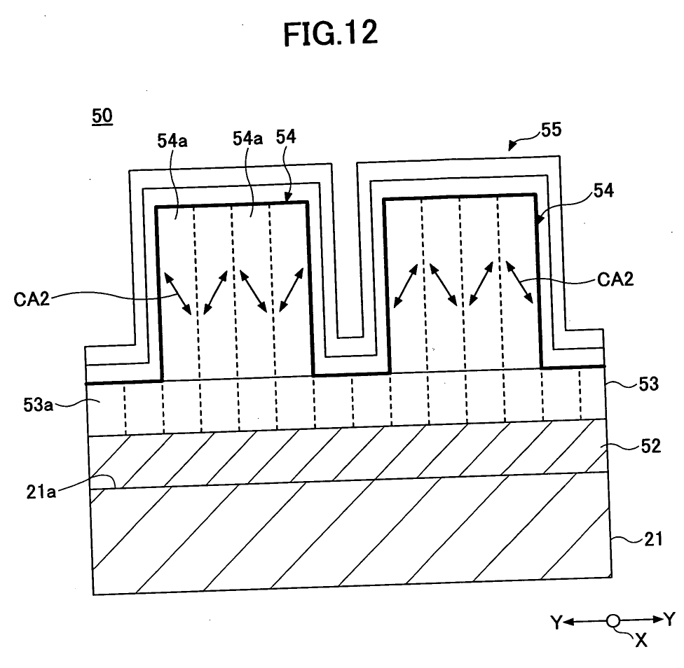

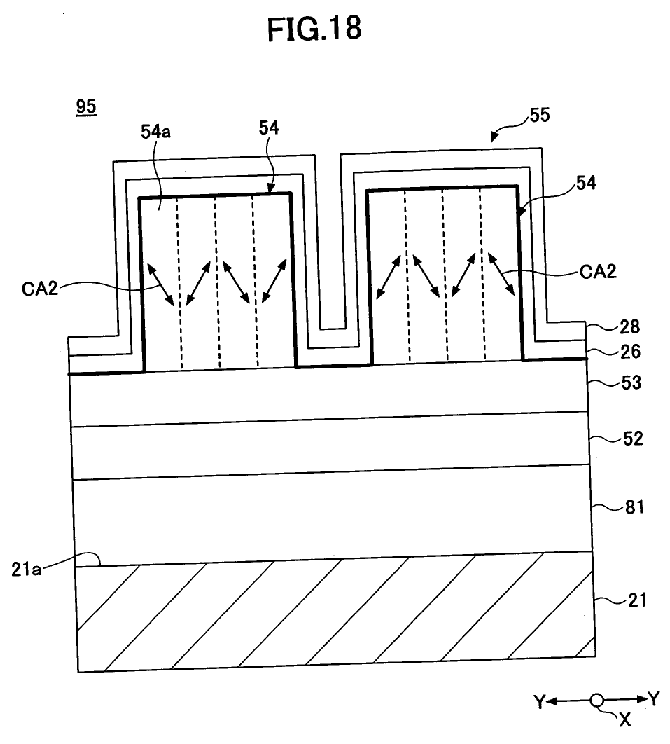

The recording layer of the recording cell may have plural ferromagnetic crystal particles, the magnetic easy axis of the crystal particle may be inclined against the substrate surface, and the element parallel with the substrate surface may face (planar direction) randomly. This is a case of magnetic recording media of fourth and tenth examples shown in FIG. 12 and FIG. 18 that are discussed below. In a case of such a magnetic recording medium, it is expected that the effects of the prevention of the side erase and the prevention of the self track erase will be small. However, it is possible to obtain larger effects of the above-mentioned prevention of the side erase and the prevention of the self track erase than for the magnetic recording medium shown in FIG. 2 or FIG. 5.

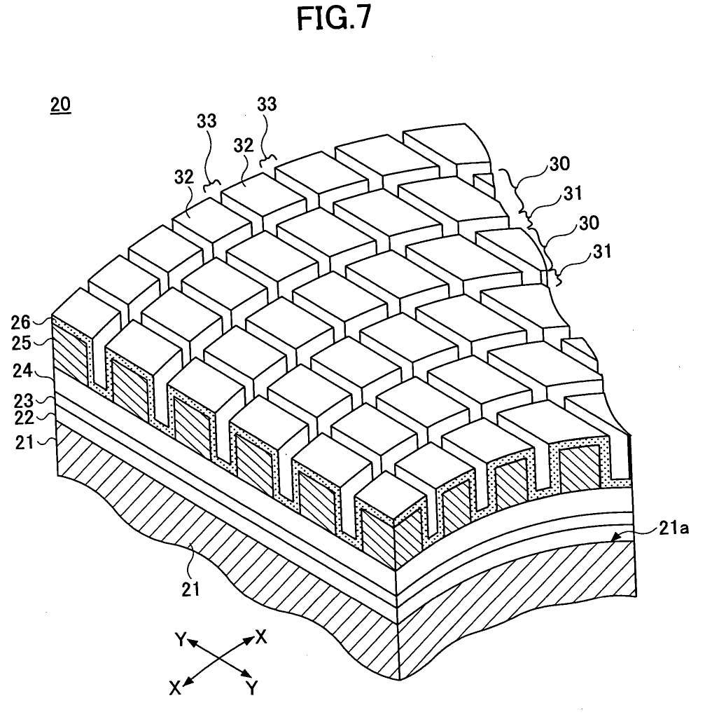

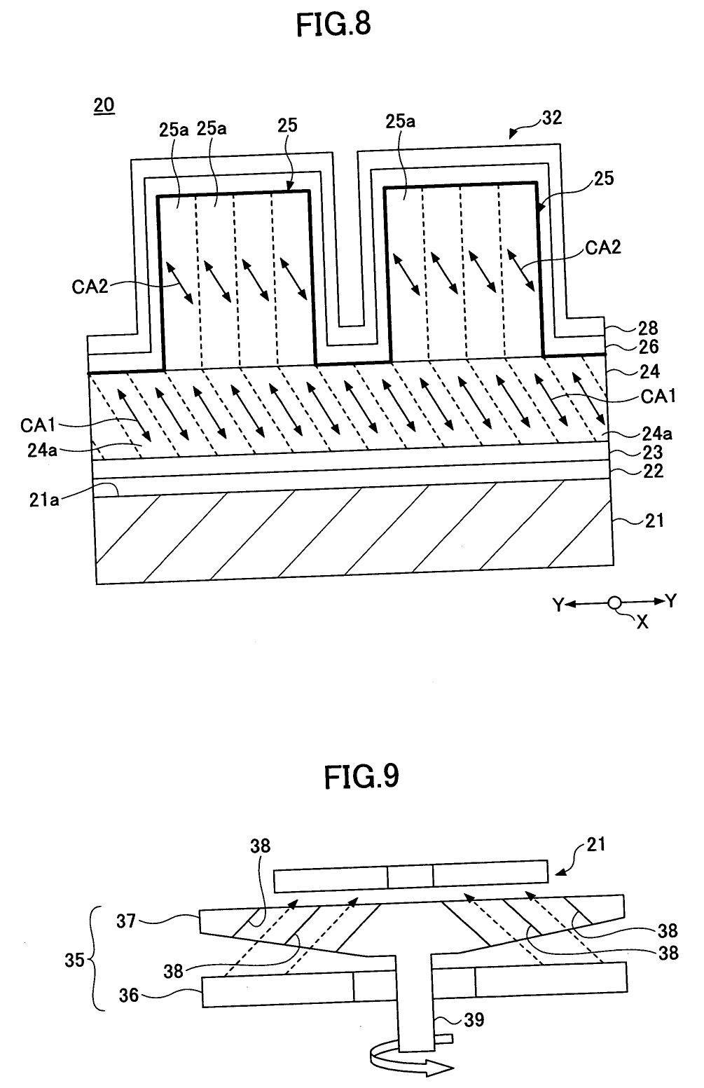

FIG. 7 is a perspective cross-sectional view of a magnetic recording medium of a first example of the first embodiment of the present invention. FIG. 8 is a cross-sectional view of the magnetic recording medium of the first example of the first embodiment of the present invention. For the convenience of explanation, illustration of a lubricating layer is omitted.

Referring to FIG. 7 and FIG. 8, a track area 30 where recording and reproducing are performed, and a track separating area 31 whereby track areas 30 neighboring at both sides in the track width direction of the track area 30 are separated from each other are provided in a magnetic recording medium 20 of a first example. In the track area 30, recording cells 32 and cell separating areas 33 put between the neighboring recording cells 32 are provided in a circumferential direction.

In the magnetic recording medium 20, a seed layer 22, a base layer 23, an intermediate layer 24, a recording layer 25 made of ferromagnetic material having a hcp structure whose main component is Co, and a protection layer 26 made of a carbon film or the like are stacked on a substrate 21 in this order. A lubricating layer 28 is formed on the protection layer 26. The recording layers 25 are separated for every recording cell 32.

The substrate 21 may be, for example, a plastic substrate, a crystallized glass substrate, a tempered glass substrate, Si substrate, aluminum alloy substrate, or the like.

The seed layer 22 may be made of non-crystalloid or fine crystallite material such as crystalloid CoW, CrTi, or NiP. It is possible to exclude an influence of crystal orientation given from a material forming the substrate to the base layer 23 by providing the seed layer 22. Therefore, a polycrystalline material of the base layer 23 is uniformly formed. Another seed layer made of material forming a B2 structure such as AlRu or NiAl may be formed on the seed layer 22. By using another seed layer made of such a material, it is possible to heighten the crystallinity of the base layer 23 formed on the seed layer.

It is preferable that the base layer 23 is selected from a Cr-Xl alloy (Xl is selected from a group consisting of Mo, W, V, B, and Ti and alloys of them) or Cr having a bcc crystal structure, and the thickness of the base layer 23 be set to be in a range between 3 nm and 10 nm. The base layer 23 is made of, for example, CrMo or CrV. By using the Cr-Xl alloy as the base layer 23, it is possible to improve the lattice matching with the intermediate layer 24 so as to improve crystallinities of the intermediate layer 24 and the recording layer 25. As a result of this, the width of an angle distribution of c axis CA2 of the crystal particles of the recording layer 25 can be narrowed.

The intermediate layer 24 is made of material having a hcp structure. The intermediate layer 24 is formed by inclining a (0001) surface against the substrate surface 21a. Because of this, the recording layer 25 having the hcp structure can easily epitaxially grow on the intermediate layer 24 and the (0001) surface of the recording layer 25 is inclined against the substrate surface. Here, the crystal particles 24a forming the intermediate layer 24 grow so as to be inclined against the substrate surface and the (0001) surface is oriented in a direction perpendicular to the growth direction.

Such an intermediate layer 24 is formed by an incident sputtering apparatus shown in FIG. 9.

It is preferable that the film thickness of the intermediate layer 24 be set to be in a range from 2 nm to 20 nm. The material of the intermediate layer 24 is selected from a group consisting of Ru, Re, non-magnetic CoCr, and CoCr-Ml alloy (Ml is selected from a group consisting of Os, Re, Ru, and Ta and alloys of them).

The recording layer 25 is made of a ferromagnetic material having a hcp structure whose main component is Co. It is preferable that CoCr, a CoCr group alloy, CoCrTa, a CoCrTa group alloy, CoCrPt, or a CoCrPt group alloy be used as the ferromagnetic material. CoCrPt-M2 (M2 is selected from a group consisting of B, Ta, Ni, Cu, Ag, Pd, Si, C, Fe, Re, Nb, and Hf and alloys of them) is more preferable from the view point of the control of the particle diameter of the crystal particles 25a of the recording layer 25.

The recording layer 25 may be made of oxide of the ferromagnetic material having the hcp structure whose main component is Co, such as CoCrPt—O. The recording layer 25 may be a mixture of the ferromagnetic material having the hcp structure whose main component is Co and an oxide such as SiO, MgO, Al₂O₃, or such as CoCrPt—SiO₂.

The crystal particles 25a of the recording layer 25 grow in a direction perpendicular to the substrate surface 21a. Since the recording layer 25 epitaxially grows on the surface of the intermediate layer 24, the recording layer 25 takes over the inclined (0001) surface of the intermediate layer 24 so that the (0001) surface inclines toward an external periphery side. Hence, since the c axis CA2 of the recording layer 25 is a magnetic easy axis, the magnetic easy axis is formed so as to be inclined to the external periphery side. The film thickness of the recording layer 25 is set to be, for example, in a range between 5 nm and 30 nm.

As shown in FIG. 8, the recording layers 25 are separated from each other for every recording cell 32. By separating the recording layers 25, the recording layer 25 substantially functions as a magnetic body of a single magnetic part. The recording layer 25 is magnetized in a single direction in the magnetized state. Since the recording layers 25 are separated in the recording direction and the track width direction, interaction working between the recording layers 25 is reduced.

As a result of this, the magnetic recording medium 20 can reduce the medium noise or track edge noise.

The recording layer 25 may include two magnetic layers and a non-magnetic connection layer put between the magnetic layers. The recording layer 25 may be a laminated body having a exchange coupled structure where the magnetic layers are exchange-coupled in a non-ferromagnetic manner via the non-magnetic connection layer 17. Materials of the magnetic layers are selected from materials similar to the above-discussed recording layer. Since the recording layer 25 has the above-discussed structure, thermal stability of the magnetization recorded in the recording layer can be improved.

As described above, the magnetic recording medium 20 of the first example is made of the recording cells 32 separated from each other in the recording direction and the track width direction. Because of this, the interaction working between the 30 neighboring recording cells 32 is reduced so that medium noise can be prevented. Since the crystal particle of the intermediate layer having the hcp structure of the magnetic recording medium 20 of the first example is provided in a state where the (0001) surface is inclined in a designated direction against the substrate surface, the (0001) surface of the crystal particle 25a of the recording layer formed on the intermediate layer is inclined by taking over (being influence by) the above discussed inclination. Because of this, the magnetic easy axis (c axis) EA of the recording layer 25 is inclined at a designated oblique angle against the substrate surface 21a. Because of this, in the magnetic recording medium 20 of the first example, since the magnetic easy axis (c axis) CA2 is inclined, the recording layer 25 of the recording cell 32 that is an object to be recorded can be magnetized by a smaller recording magnetic strength and therefore good writeability can be obtained. In addition, in the magnetic recording medium 20 of the first example, the oblique planar direction of the c axis CA2, namely magnetic easy axis, is set to be in the track width direction so that the side erase can be prevented. In addition, the oblique planar direction of the magnetic easy axis is set to be in the recording direction so that the self track erase can be prevented. Furthermore, by setting the oblique planar direction of the magnetic easy axis in both the track width direction and the recording direction, both the side erase and the self erase can be prevented.

Next, a manufacturing method of the magnetic recording medium of the first example is discussed with reference to FIG. 7 through FIG. 9. First, the seed layer 22 and the base layer 23 are formed in this order on the substrate 21 by using the sputtering method. Next, the intermediate later is formed in an oblique incidence method by using the sputtering apparatus shown in FIG. 9.

FIG. 9 is a cross-sectional view of a sputtering apparatus for explaining a method for forming a base layer of the recording medium of the first example of the first embodiment of the present invention. Referring to FIG. 9, a sputtering apparatus 35 includes a shield part 37 provided between a sputtering target 36 and a substrate 21. Opening parts 38 are provided in the shield part 37. The opening part 38 pierces the shield part 37 so as to spatially connect the sputtering target 36 and the substrate 21. The opening part 38 is formed in a direction from a side of the sputtering target 36 to a side of the substrate 21 and in a direction from an external circumferential side to an internal circumferential side of the substrate 21. That is, only sputtering particles going from the external circumferential side to the internal circumferential side among the sputtering particles coming from the sputtering target 36 selectively permeate. As a result of this, as shown in FIG. 8, the crystal particles 24a inclining to the external circumferential side against the substrate surface 21a are formed on the base layer 23 of the substrate 21. Here, it is preferable that the oblique angle be set to be between 10 and 80 degrees from the perspective of angle control of the c axis CA1 of the intermediate layer.

In the crystal particle 24a, the c axis CA1 having the hcp structure is formed along the growth direction and the (0001) surface is formed in a direction perpendicular to the c axis CA1. The shield part 37 rotates with respect to a rotational axis coaxially with a central axis passing through a center of the substrate 21 perpendicular to the substrate surface 21a so that the intermediate layer 24 can be formed uniformly. In addition, it is possible to control the oblique direction against the substrate surface 21a of the c axis CA1 of the crystal particle 24a by quickening the rotational speed. For example, it is possible to control the oblique planar direction from the track width direction to the recording direction side by quickening the rotational speed.

By using this sputtering apparatus 35, the sputtering target made of material having the hcp structure is used and the shield part 35 is rotated so that the intermediate layer 24 having a film thickness of, for example, 2 nm through 20 nm is formed.

Next, the recording layer 25 is formed by using the sputtering apparatus. More specifically, by using the sputtering target made of the material of the recording layer, the sputtering particles are incident in a direction substantially perpendicular to the substrate surface so that the recording layer 25 having a film thickness of 5 nm through 30 nm is formed. Thus, the recording layer 25 covering the intermediate layer 24 can be formed.

Next, a resist film (not shown) is formed on the recording layer 25 so that a pattern is formed on the resist film by a photolithography method. As a pattern forming method for the resist film, a method whereby a photo mask having a pattern is made in advance, ultraviolet light such as g-ray or i-ray, or X-ray is projected in a whole by using the photo mask and a projection aligner, and the pattern is formed on the resist film by exposure, or a developing process may be used. Alternatively, a method whereby a pattern may be directly formed on the resist film by scanning with a KrF laser, ArF laser, far ultraviolet ray such as F₂, electron rays, ion beam, electron beam, or the like may be used. A method whereby a pattern is formed by using an interference of laser light may be used (See Savas et al., J. Appl. Phys, Vol 85 (1990) pp. 6160). In addition, so-called nano print lithography may be used.

A mold where a pattern of the recording cell is formed in advance as a concave and convex part is heated and pressed to a resist film or photo-curing resin formed on the recording layer 25 so that a pattern is formed in the nano print lithography.

Next, the recording layer 25 is selectively removed by dry etching such as the RIE (Reactive Ion Etching) method wherein a resist film having patterns is used as a mask so that the pattern of the recording cell 32 is formed. At the time of etching, as shown in FIG. 7, only a recording layer functioning as a cell separating area 33 or a track separating area 31 may be removed. In addition, the intermediate layer 24, the base layer 23, or the seed layer 22 may be removed.

Then, the protection film 26 covering a surface of the intermediate layer 24 and the patterned recording layer 25 is formed by a CVD method or sputtering method. Next, a lubricating agent is applied to a surface of the protection film 26 so that a lubricating layer 28 is formed. Thus, the magnetic recording medium 20 of the first example is made.

In this manufacturing method, the intermediate layer 24 is formed by an oblique incidence method and the oblique direction of the crystal particle 24a is controlled, so that a axis CA2 of the recording layer 25 is formed in a desirable direction. Since the recording layer 25 functioning as the cell separating area 33 or the track separating area 31 is removed by the photo lithography method and the etching method so that the recording cell 32 is formed, it is possible to form the recording cell 32 without damaging the recording layer 25 of the recording cell 32. In addition, since the recording layer 25 is a thin layer, the recording layer 25 can be easily removed by dry etching.

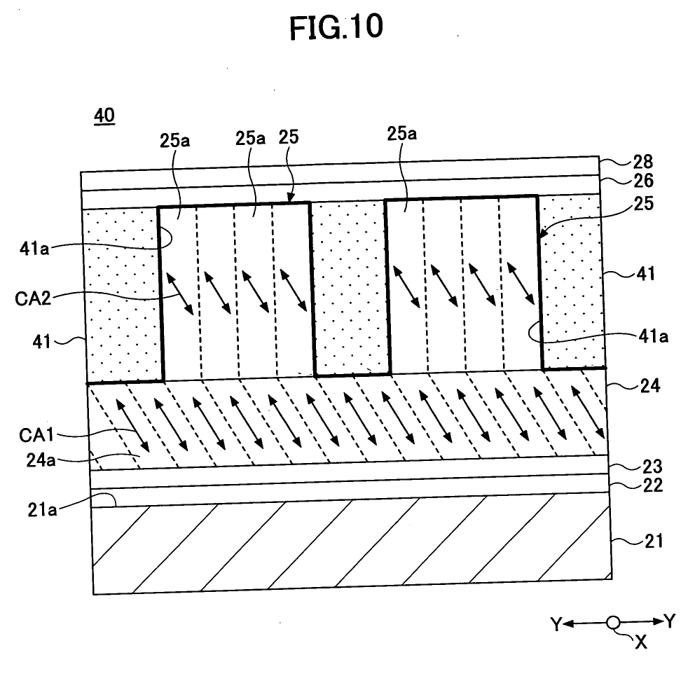

FIG. 10 is a cross-sectional view of a magnetic recording medium of a second example of the first embodiment of the present invention. FIG. 10 shows a cross section taken along the track direction. In FIG. 10, parts that are the same as the parts shown in FIGS. 1-9 are given the same reference numerals, and explanation thereof is omitted.

Referring to FIG. 10, in a magnetic recording medium 40 of the second example, the seed layer 22, the base layer 23, the intermediate layer 24, an anode oxide alumina film 41 having pores, the protection layer 26, and the lubricating layer 28 are stacked on a substrate 21 in this order. The recording layer 25 is formed in the pore 41a. The magnetic recording medium 40 is the same as the magnetic recording medium of the first example shown in FIG. 7 and FIG. 8 other than that the recording layer 25 is formed in the anode oxide alumina film 41 and the pore 41a, and therefore explanation thereof is omitted.

The anode oxide alumina film 41 is made of an amorphous alumina film and a large number of pores 41a piercing in a thickness direction of the amorphous alumina film. The anode oxide alumina film 41 is formed by converting the aluminum film by using the anode oxide method. The pore 41a is formed in a state where a concavity formed on a surface of the aluminum film in advance or in a self-organized manner is a starting point.

The thickness of the anode oxide alumina film 41 is set in a range equivalent to the thickness of the recording layer 25 formed in the pore 41a. It is preferable that the thickness of the anode oxide alumina film 41 be set in a range between 5 nm and 30 nm.

The recording layer 25 is selected from a material the same as the material of the magnetic recording medium of the first example. The recording layer 25 follows the oblique (0001) surface of the intermediate layer 24 and the (0001) surface is made of oblique crystal particles 25a. That is, the c axis CA of the crystal particle 25a is inclined against the substrate surface 21a. The recording layer 25 formed in the pore works as a recording cell. Since the pore 41a has a cylindrical shaped configuration, a recording cell having a columnar shaped configuration is formed.

In the magnetic recording medium 40 of the second example, as well as the magnetic recording medium of the first example, the recording layer 25 formed in the pore 41a is inclined in a designated oblique direction so that the same effect as the magnetic recording medium of the first example is obtained. In addition, since the surface of the recording layer 25 is substantially consistent with the surface of the anode oxide alumina film 41, the surface of the magnetic recording medium 40 is flattened. Therefore, since the magnetic head can be flown close to the surface of the magnetic recording medium 40, a reproducing output or a reproducing resolution at a high recording density is improved so that the S/N ratio is improved.

Next, a manufacturing method of the magnetic recording medium 40 of the second example is explained with reference to FIG. 10. First, the seed layer 22, the base layer 23, and the intermediate layer 24 are formed in the substrate 21 by using the same method as the method for the magnetic recording medium of the first example.

Next, the aluminum film (not shown) is formed on the intermediate layer 24 by a deposition method, sputtering method, CVD method or the like, and then the aluminum film is converted to the anode oxide alumina film by an anode oxide method. For example, a sulfuric acid bath, phosphoric acid bath, or oxalic acid bath is used for the anode oxide method for the aluminum film. The substrate 21 where the aluminum film is formed is dipped in such a bath. In a case where the seed layer 22, the base layer 23, the intermediate layer 24 or the substrate 21 is conductive, an electric voltage is applied in a state where the substrate 21 functions as an anode and a carbon or platinum electrode whose part is dipped in the bath functions as a cathode. Under this structure, the aluminum film is converted into the anode oxide alumina film 41 made of amorphous alumina simultaneously with the pore 41a piercing from the surface of the anode oxide alumina film 41 to the intermediate layer 24 being formed. In addition, since the pores 41a are not bonded to each other, the recording layers 25 formed after this can be separated.

The arrangement of the pores 41a can be controlled by providing a concave part on the surface of the aluminum film by using a photolithography method, an etching method or a stamping method, prior to an anode oxide process. This is because the concave part is a starting point of forming the pore. This control may be done by a two-steps anode oxide method whereby the concave part is formed by applying a voltage determining the interval of the pores in a first step of the anode oxide process and the pores are formed in the concave part by applying the voltage causing the anode oxide reaction in a second step anode oxide process.

Next, the recording layer 25 is formed so as to fill in the pore 41a by the sputtering method. Details of the forming method of the recording layer 25 are the same as the method for the magnetic recording medium of the first example. The recording layer 25 epitaxially grows on the intermediate layer 24 and the (0001) surface is inclined.

Next, the recording layer is flattened by a CMP (Chemical Mechanical Polishing) method so that a surface of the anode oxide alumina film 41 is exposed and the recording layer 25 stacked on the surface of the anode oxide alumina film is removed. Then, the protection film 26 and the lubricating layer 28 are formed in the same way as the magnetic recording medium of the first example.

In this manufacturing method, since the recording layer 25 is formed in the pore so that the recording cell is formed, it is not necessary to etch the recording layer 25. Since patterning of the recording layer such as patterning in the manufacturing method of the magnetic recording medium of the first example is not necessary, the process can be drastically simplified.

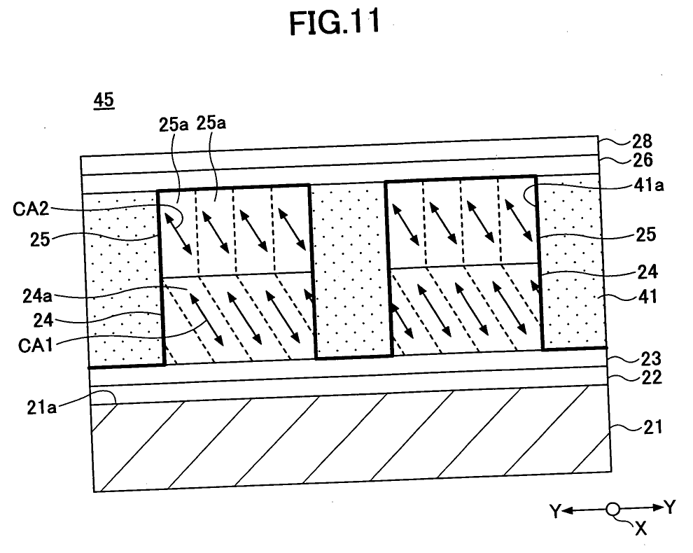

FIG. 11 is a cross-sectional view of a magnetic recording medium of a third example of the first embodiment of the present invention. FIG. 11 shows a cross section taken along the track direction. The magnetic recording medium of the third example is a modified example of the magnetic recording medium of the second example shown in FIG. 10. In FIG. 11, parts that are the same as the parts shown in FIGS. 1-10 are given the same reference numerals, and explanation thereof is omitted.

Referring to FIG. 11, in a magnetic recording medium 45 of the third example, the anode oxide alumina film 41 is provided on the base layer 23 and the intermediate layer 24 and the recording layer 25 are formed in the pore 41a of the anode oxide alumina film. Such a structure is especially effective in a case where an aspect ratio (ratio of the depth of the pore and the diameter of a cross section parallel with a substrate surface of the pore) of the pore 41a is sufficiently small. The magnetic recording medium 45 has the same effect as the magnetic recording medium of the second example.

Next, a manufacturing method of the magnetic recording medium 45 of the third example is discussed. As well as the magnetic recording medium of the first example, the seed layer 22 and the base layer 23 are formed on the substrate 21 and then the anode oxide alumina film 41 is formed on the base layer 23. The anode oxide alumina film 41 is formed by the same method as the method for the magnetic recording medium of the second example.

After that, the intermediate layer 24 is formed in the pore of the anode oxide alumina film by the oblique sputtering method shown in FIG. 9. Then, the recording layer 25 is formed in the same way as the way for the magnetic recording medium of the second example. Next, the flattening process is implemented and the protection film 26 and the lubricating layer 28 are formed.

According to this manufacturing method, the same effect as the effect achieved by the manufacturing method for the magnetic recording medium of the second example is achieved. In addition, the recording layer 25 is formed just after the intermediate layer 24 is formed. Therefore, the surface of the intermediate layer 24 may not be contaminated. The recording layer 25 is formed in a state where the intermediate layer 24 is activated. Hence, the recording layer 25 can be formed on the intermediate layer 24 in a good crystalline state.

FIG. 12 is a cross-sectional view of a magnetic recording medium of a fourth example of the first embodiment of the present invention. In FIG. 12, parts that are the same as the parts shown in FIGS. 1-11 are given the same reference numerals, and explanation thereof is omitted.

Referring to FIG. 12, in the magnetic recording medium 50 of the fourth example, the orientation control layer 52, the base layer 53, the recording layer 54, the protection layer 26 made of, for example, a carbon film, and the lubricating layer 28 are formed on the substrate 21.

The orientation control layer 52 made of the non-magnetic material including nitrogen and oxygen has a film thickness of, for example, 1 nm through 150 nm. The nitrogen and oxygen included in the orientation control layer 52 may be taken from the atmosphere at the time when the orientation control layer 52 is stacked or may be included in the sputtering target in advance. A material including nitrogen and oxygen of amorphous metal of NiP, AlV, AlTi, CoW, or CrTi, crystalline metal having a B2 structure such as RuAl, NiAl, or FeAl, a material including nitrogen and oxygen of crystalline metal having a bcc structure such as Cr, CrNb, CrW, CrMo, or CrV, or a material including nitrogen and oxygen and having a bcc structure of Au, Al, Ag, Pt or an alloy of these chemical elements, may be used as a non-magnetic material suitable for the orientation control layer 25.

The thickness of the base layer 53 may be set in a range of, for example, between 1 nm and 150 nm. The base layer 53 is made of Cr or a Cr group alloy whose main component is Cr. The Cr group alloy is formed by a Cr-X2 alloy having a bcc structure (body-centered cubic structure). An additional element X2 is selected from a group consisting of W, Mo, Nb, Ta, V and an alloy of these elements. The film thickness of the base layer 53 is set to be in a range of, for example, between 1 m and 150 nm. It is preferable that the thickness be set be in a range between 5 and 30 nm. The base layer 53 is poly-crystal made of a large number of the crystal particles 53a. A (110) crystal surface of the crystal particle 53a grows in a direction perpendicular to the substrate surface 21a by action of the orientation control layer 52. As a result of this, a (110) crystal surface appears on the surface of the base layer 23 and a (10-11) surface of the recording layer 54 is coordinated. The crystal particle 54a wherein c axis CA2 is at an oblique angle is formed on the recording layer 54.

A grating constant of the base layer 53 can be controlled by properly selecting a kind or included amount of the additional element X2. Because of this, lattice matching of the (110) surface of the base layer and the (10-11) surface of the recording layer can be heightened. The base layer 53 may include Cr, the Cr group alloy whose main component is Cr, nitrogen, or oxygen.

The film thickness of the recording layer 54 may be set in a range of between, for example, 5 nm and 30 nm and the recording layer 54 is selected from material the same as the material for the magnetic recording medium of the first example. The recording layer 54 is poly-crystal made of the crystal particles 54a. The crystal particle 54a epitaxially grows on the surface of the base layer 53 and extends in a direction perpendicular to the substrate surface 21a. Since the (110) crystal surface appears on the surface of the base layer 23 by action of the orientation control layer 23, the crystal particle 54a grows so that the (10-11) crystal surface is lattice-matched. Therefore, the (10-11) surface of the crystal particle 54a is parallel with the substrate surface 21a. The c axis A2 of the crystal particle 54a is inclined at pproximately 28 degrees against the (10-11) crystal surface. Therefore, the c axis CA2 of the crystal article 54a is inclined at approximately 28 degrees against the substrate surface 21a. If all of the crystal particles 24a are in the above-mentioned state, the c axis CA2 is inclined at 28 degrees±2 degrees against the substrate surface 21a, as considering the distribution of the directions of the c axes CA2.

The grating constants for the crystal particles 54a or directions of the crystal surfaces are distributed to some extent. The c axes CA have a distribution of the directions as corresponding to the action of the orientation control layer 22. As a result of this, the oblique angle formed by the c axis CA2 of the crystal particle 54a and the substrate surface 21a is larger than 0 degrees and equal to or less than 30 degrees. It is preferable that the angle formed by the c axis CA2 of the crystal particle 54a and the substrate surface 21a be equal to or larger than 25 degrees and equal to or less than 30 degrees from the view point of reduction of the recording magnetic field strength. Such a range can be obtained by stacking a non-magnetic material in the atmosphere of argon gas and oxygen gas or nitrogen gas having a concentration of 2 volume % through 40 volume % at the time when the orientation control layer 52 is formed by the sputtering method.

The oblique directions of the c axis CA2 of the crystal particles 54a are different for every crystal particle, namely are random. This is different from the crystal particles of the recording layers of the first through third magnetic recording media that have designated oblique directions. Because of this, the magnetic easy axis of the whole of the recording layer has a designated oblique angle against the substrate surface 21a equal to the oblique angle of the c axis CA2. A direction parallel with the substrate surface is an isotropic direction.

In the magnetic recording medium 50 of the fourth example, by providing the orientation control layer 52, a (110) surface appears on the surface of the base layer 53 by action of the orientation control layer 52 so that the recording layer 54 is formed by coordinating the (10-11) surface. As a result of this, the c axis CA2 of the crystal particle 54a of the recording layer 54 is inclined at a designate oblique angle and the oblique angle is different for every crystal particle. As a result of this, the magnetic easy axis of the recording layer 54 has a designate oblique angle against the substrate surface 21a equal to the oblique angle of the c axis CA2. A direction parallel with the substrate surface is an isotropic direction. Therefore, the magnetic recording medium 50 of the fourth example, as well as the magnetic recording medium shown in FIG. 6, can prevent both the side erase and the self track erase. The magnetic recording medium 50 of the fourth example has the same effect as the effect achieved by the magnetic recording medium of the first example.

The manufacturing of the magnetic recording medium of the third example is done by the forming method for respective layers. The pattern of the recording cell 55 is formed by the same method for the magnetic recording medium of the first example.

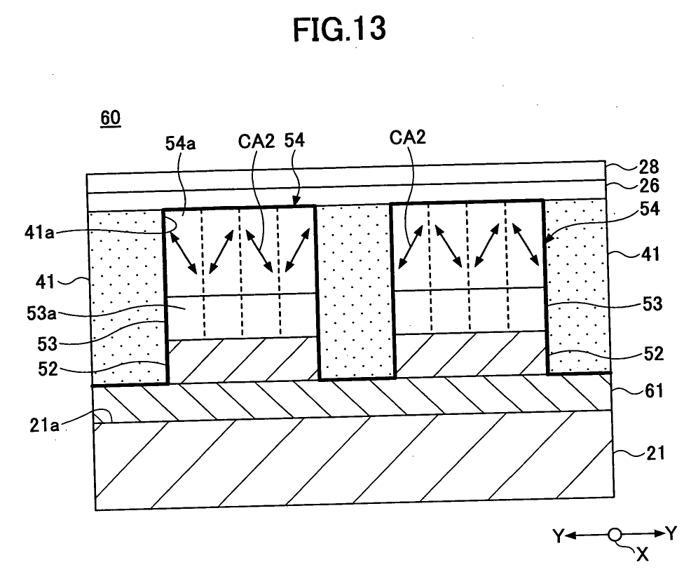

FIG. 13 is a cross-sectional view of a magnetic recording medium of a fifth example of the first embodiment of the present invention. The magnetic recording medium of the fifth example is a combination of the magnetic recording media of the second, fourth, and fifth examples. In FIG. 13, parts that are the same as the parts shown in FIGS. 1-12 are given the same reference numerals, and explanation thereof is omitted.

Referring to FIG. 13, in the magnetic recording medium 60 of the fifth example, a conductive layer 61, an anode oxide alumina film having pores 41a, the protection layer 26, and a lubricating layer 28 are stacked on the substrate in this order. The orientation control layer 52, the base layer 53, and the recording layer 54 are formed in this order in the pore 41. The magnetic recording medium 60 has the same structure as the structure of the magnetic recording medium of the fourth example other than that the orientation control layer 52, the base layer 53, and the recording layer 54 are formed in this order in the pore 41.

The orientation control layer 52, the base layer 53, and the recording layer 54 are selected from the same materials as the material for the magnetic recording medium of the fourth example and are made by the same method as the method for the magnetic recording medium of the fourth example. Therefore, the c axis CA2 of the crystal particle 54a of the recording layer 54 has a designated oblique angle and the oblique angle is different for every crystal particle. As a result of this, in the magnetic recording medium 60 of the fifth example, the magnetic easy axis of the recording layer 54 has the designate oblique angle against the substrate surface 21a equal to the oblique angle of the c axis CA2. The planar direction parallel with the substrate surface is an isotropic direction. Therefore, both the side erase and the self track erase can be prevented.

In addition, in the magnetic recording medium 60 of the fifth example, as well as the magnetic recording medium of the second example, the S/N ratio is improved. Furthermore, in the magnetic recording medium 60, the orientation control layer 52, the base layer 53 and the recording layer 54 are formed in the pore 41 by a sputtering method whereby an incident direction is perpendicular to the substrate surface. Therefore, a space such as a shadow may not be in the pore 41a and it is possible to easily fill the pore 41a with the layers 52 through 54.

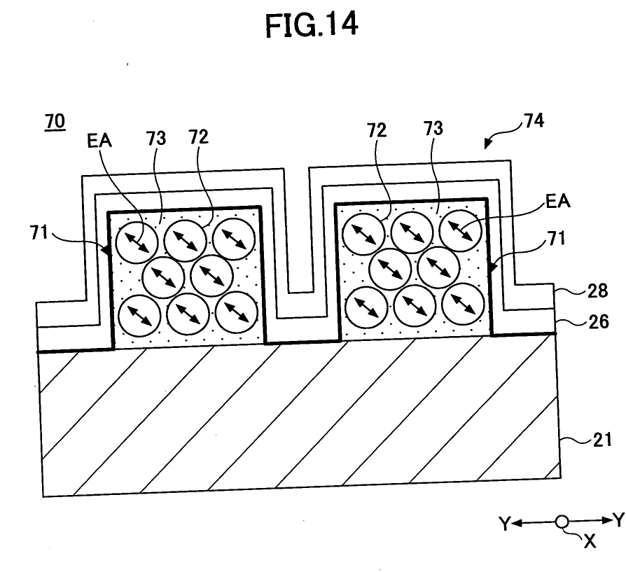

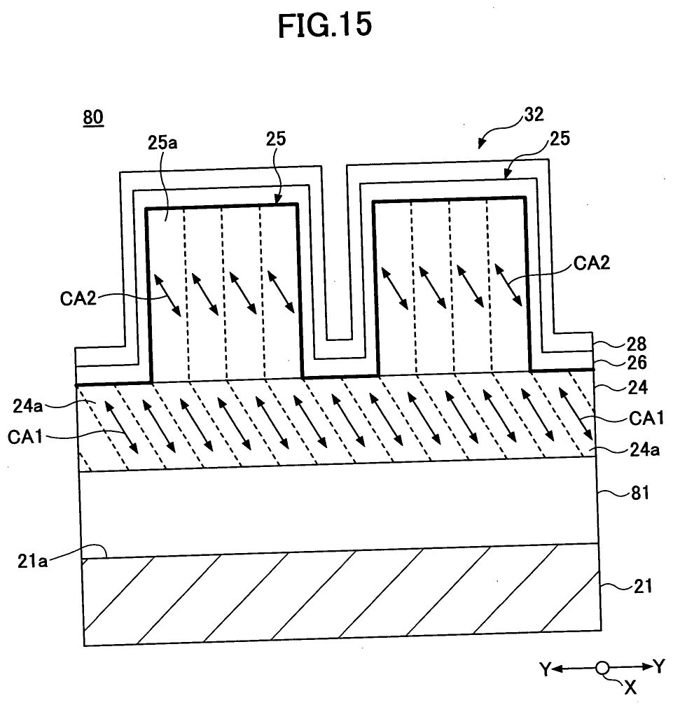

FIG. 14 is a cross-sectional view of a magnetic recording medium of a sixth example of the first embodiment of the present invention. In FIG. 14, parts that are the same as the parts shown in FIGS. 1-13 are given the same reference numerals, and explanation thereof is omitted.

Referring to FIG. 14, in a magnetic recording medium 70 of the sixth example, a recording layer 71, the protection film 26 and the lubricating layer 28 are stacked on the substrate 21 in this order. A recording cell 74 is formed in a state where the recording layers 71 are separated from each other.

The recording layer 71 is formed by plural hard magnetic material nano particles 72 and a carbon phase 73 filling a part where the particles 72 are not situated. The thickness of the recording layer 71 is set to be between 3 nm and 50 nm. In addition, the recording layer 71 may have a structure where the hard magnetic material nano particles 72 are staked in a single layer state or plural layers state.

The hard magnetic material nano particle 72 is made of a ferromagnetic material whose main component is an alloy of one of FePt, FePd, and CoPt. This alloy has high magnetic anisotropic energy and a high coercive force.

Fe_{100-X}Pt_{X}, Fe_{100-X}Pd_{X}, Co_{100-X}Pt_{X}, and Co_{100-X}Pd_{X} can be used as a ferromagnetic material of the hard magnetic material nano particle 72. It is preferable that X be set to 20 at % through 60 at %, more preferably 35 at % through 55 at %. By setting a composition to the above mentioned range, it is possible to achieve higher magnetic anisotropic energy and a higher coercive force. As the ferromagnetic material of the hard magnetic material nano particle 72, Fe₃Pt, FePt₃, Fe₃Pd, FePd₃, Co₃Pt, and CoPt₃ can be used.

In addition, as the ferromagnetic material of the hard magnetic material nano particle 72, for example, an additional element selected from a group consisting of Ag, Au, Cu Sb, and Ni may be added to either FePt alloy, FePd alloy or CoPt alloy. The above-mentioned additional element can improve the writeability by reducing the magnetic anisotropic energy as corresponding to the size of the recording magnetic field of the magnetic head in a case where the magnetic anisotropic energy is too high when only the above mentioned alloy is used.

The average particle diameter of the hard magnetic material nano particle 72 is set to be in a range equal to or larger than 2 nm and equal to or smaller than 10 nm. If the average particle diameter is larger than 10 nm, the volume of the carbon phase 73 between the hard magnetic material nano particles 72 becomes large so that the medium noise is increased. If the average particle diameter is smaller than 2 nm, the hard magnetic material nano particles 72 easily become super-paramagnetic at room temperature so that it is difficult to keep the ferromagnetism.

A standard deviation of the particle diameter of the hard magnetic material nano particles 72 is set to be in a range less than 10% of the average particle diameter. If the standard deviation of the particle diameter exceeds 10% of the average particle diameter, the distribution of magneto-static interaction of the hard magnetic material nano particles 72 becomes large so that the medium noise is increased.

In addition, the magnetic easy axis EA of the hard magnetic material nano particles 72 is inclined in a designated oblique direction against the substrate surface 21a. The magnetic easy axis EA of the hard magnetic material nano particles 72 is set by a magnetic field direction at the time of heat treatment in the magnetic field for forming the hard magnetic material nano particles 72.

Next, a forming method of the recording layer of the magnetic recording medium 70 of the sixth example is discussed. First, a hard magnetic nano particle precursor is formed as a precursor of the hard magnetic nano particle 72 by a well-known chemical synthesis method. Then, the hard magnetic nano particle precursor obtained by spin coating is applied on the substrate 21. Then, the heat treatment in the magnetic field is applied so that the magnetic field is applied and heating is applied in a designated direction for crystal regularization and orientation of the hard magnetic nano particle precursor. At the time of the heating treatment in the magnetic field, the magnetic field is applied along a direction in which the magnetic easy axis EA is set. For example, heating temperature is set to be between 300° C. and 500° C., an applied magnetic field is set to be between 10 kOe and 50 KOe, and a process time is set to be between 10 minutes and 120 minutes. Thus, the hard magnetic material nano particles 72 having a high coercive force can be obtained and the easily magnetizable axes EA of the hard magnetic material nano particles 72 are formed so as to be inclined in a designated oblique direction against the substrate surface.

Next, the recording layer is etched by the same method as the method for the magnetic recording medium of the first example so that the recording cell is formed. Then, the protection film and lubricating layer are formed.

In the magnetic recording medium 70 of the sixth example, the recording layer of the recording cell 74 is made of the hard magnetic nano particle. The magnetic easy axis EA of the recording layer 71 is inclined against the substrate surface in a designated oblique direction. Hence, the magnetic recording medium 70 of the sixth example has the same effect as the effect achieved by the magnetic recording medium of the first example. In addition, in the magnetic recording medium 70 of the sixth example, the desired direction of the magnetic easy axis EA can be set in a direction in which the magnetic field at the time of the heating treatment in the magnetic field is applied.

Furthermore, in the magnetic recording media of the first through sixth examples, soft magnetic lining layers may be provided on the substrates.

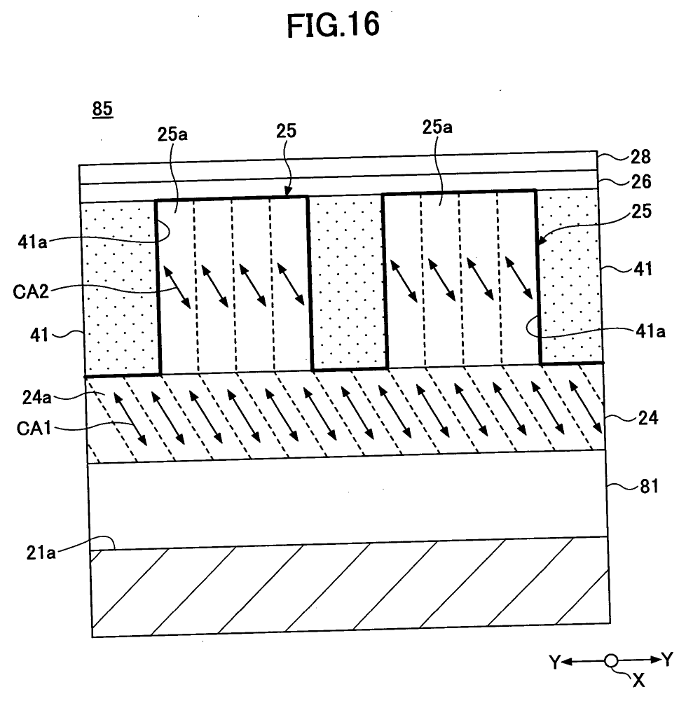

FIG. 15 through FIG. 20 are cross-sectional views of magnetic recording media of seventh through twelfth examples of the first embodiment of the present invention. In FIG. 15 through FIG. 20, parts that are the same as the parts shown in FIGS. 1-14 are given the same reference numerals, and explanation thereof is omitted.

Referring to FIG. 15 through FIG. 20, magnetic recording media 80, 90, 95, 100 and 105 have the same structures as structures of the magnetic recording media of the first through sixth examples other than a soft magnetic lining layer 81 is provided on the substrate 21.

The soft magnetic lining layer 81 has, for example, a film thickness of 10 nm through 2 μm. The soft magnetic lining layer 81 is made of non-crystalloid or fine crystallite soft magnetic material including at least one kind of an element selected from a group consisting of Fe, Co, Ni, Al, Si, Ta, Ti, Zr, Hf, V, Nb, C and B. As the sift magnetic material, FeSi, FeAlSi, FeTaC, CoNbZr, CoZrTa, CoCrNb, NiFe, and NiFeNb can be used. The soft magnetic lining layer 81 may be a single layer or plural layers.

The soft magnetic lining layer 81 may be formed by stacking the first soft magnetic layer, the non-magnetic connection layer, and the second soft magnetic layer in this order. Materials of the first soft magnetic layer and the second soft magnetic layer of the soft magnetic lining layer 81 may be selected from a group consisting of materials of the soft magnetic lining layer 81. The non-magnetic connection layer is formed by Ru, Rh, Ir, Ru group alloy, a Rh group alloy, or an Ir group alloy. The non-magnetic connection layer has a film thickness of between 0.5 nm and 1.0 nm. The magnetizations of the first soft magnetic layer and the second soft magnetic layer are exchange-coupled in an anti-ferromagnetic manner to each other by setting the film thickness of the non-magnetic connection layer to be in the above-mentioned range. Since the soft magnetic lining layer 81 has a so-called stacked ferri laminated structure, a magnetic domain is prevented from being formed in the first soft magnetic layer and the second soft magnetic layer and there is no generation of a noise spike due to the movement of a magnetic domain wall.

In the magnetic recording media 80, 85, 90, 95, 100 and 105 of seventh through twelfth examples of the first embodiment of the present invention, since the soft magnetic lining layer is provided, the direction of the recording magnetic field is perpendicular to the substrate surface 21a in the recording cell to be recorded at the time when recording is implemented by using the recording element for vertical recording. Hence, it is possible to achieve good writeability. In addition, in the magnetic recording media 80, 85, 90, 95, 100 and 105 of seventh through twelfth examples of the first embodiment of the present invention, the side erase and/or the self track erase can be prevented.

### Second Embodiment

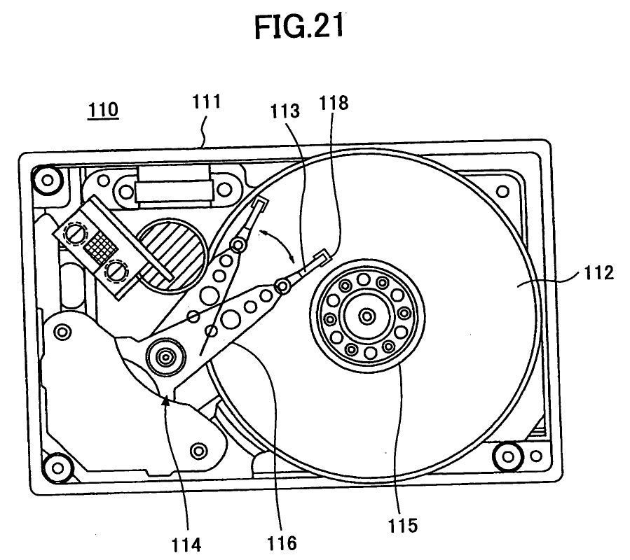

FIG. 21 is a plan view showing a main part of a magnetic storage apparatus of a second embodiment of the present invention. Referring to FIG. 21, a magnetic storage apparatus 110 of this embodiment includes a housing 111, and a magnetic disk 112, a magnetic head 113, an actuator unit 114, and others stored in the housing 111. The magnetic disk 112 is fixed to a hub 115 and driven by a spindle motor (not shown). A base part of the magnetic head 113 is fixed to an arm 116. The magnetic head 113 is installed in the actuator unit 114 by the arm 116. The magnetic head 113 is rotated in a diameter direction of the magnetic disk 112 by the actuator unit 114. In addition, an electronic substrate for controlling recording and reproducing, the magnetic head position, the spindle motor, and others is provided at a rear side of the housing 111.

The magnetic head 113 is formed by a reproducing head having a single magnetic pole type recording head and GMR (Giant Magneto Resistive) element.

The reproducing head includes the GMR element. The GMR element obtains information recorded in the recording layer of the magnetic disk 112 by sensing the direction of the magnetic field, wherein the magnetization of the magnetic disk 112 is emanated as a resistance change. Instead of the GMR element, a TMR (Ferromagnetic Tunnel Junction Magneto Resistive) element may be used.

The single magnetic pole type recording head 113 includes a main magnetic pole, a return yoke, and a recording coil. The main magnetic pole made of the soft magnetic material is used for applying the recording magnetic field to the magnetic disk 112. The return yoke is magnetically connected to the main pole. The recording coil guides a recording magnetic field to the main magnetic pole and the return yoke. The single magnetic pole type recording head 113 magnetizes the recording layer by applying the recording magnetic field from the main magnetic pole in a direction perpendicular to the substrate surface of the magnetic disk 112.

The magnetic disk 112 is any of the magnetic recording media of the first through twelfth examples. By using the magnetic recording media of the first through twelfth examples, as discussed in the first embodiment, it is possible to reduce the medium noise and to obtain good writeability for the recording cell to be recorded. In addition, the side erase and/or the self track erase can be prevented.

In a case where the magnetic head 113 is an in-plane recording type recording element such as a ring type thin film recording element, it is preferable to make an element parallel with the substrate surface of the magnetic easy axis of the recording layer of the magnetic recording media of the first through twelfth examples to be oriented in a direction against the recording direction in a range between 0 degrees and ±45 degrees.

Under this structure, it is possible to maintain the reproducing output and prevent both the side erase and the self track erase.

According to this embodiment, it is possible to realize the magnetic storage apparatus wherein the medium noise can be reduced and both the side erase and the self track erase are prevented.

A basic structure of the magnetic storage apparatus 110 is not limited to the structure shown in FIG. 21. The magnetic recording medium of this embodiment is not limited to the magnetic disk 112. For example, the magnetic storage apparatus 110 may be a helical scan type or lateral magnetic tape apparatus. The magnetic head for vertical recording is mounted on a cylinder head in a case where the magnetic head is a helical scan type, and mounted in a tape width direction in a case where the magnetic head is a lateral type.

The present invention is not limited to these embodiments, but variations and modifications may be made without departing from the scope of the present invention.

This patent application is based on Japanese priority patent application No. 2005-105239 filed on Mar. 31, 2005, the entire contents of which are hereby incorporated by reference.

What is claimed is:

1. A magnetic recording medium, comprising:
a plurality of recording cells separated from each other on a substrate in a recording direction and a track width direction perpendicular to the recording direction;
wherein the recording cell includes a recording layer; and
the recording layer has a magnetic easy axis inclining in a designated oblique direction against a surface of the substrate.

2. The magnetic recording medium as claimed in claim 1,
wherein a base layer having a hcp structure is provided between the substrate and the recording layer;
a c axis of the base layer is inclined against the substrate surface;
the recording layer is made of a ferromagnetic material having a hcp structure wherein Co is a major ingredient; and
the recording layer is epitaxially grown on the base layer.

3. The magnetic recording medium as claimed in claim 1,
wherein an anodic oxidation aluminum film having a plurality of pores is provided on the substrate; and
the recording cell is made of the recording layer filling in the pore.

4. The magnetic recording medium as claimed in claim 3,
wherein a base layer having a hcp structure is provided between the substrate and the recording layer;
a c axis of the base layer is inclined against the substrate surface;
the recording layer is made of a ferromagnetic material having a hcp structure wherein Co is a major ingredient; and
the recording layer is epitaxially grown on the base layer.

5. The magnetic recording medium as claimed in claim 4,
wherein the base layer is formed in the pore.

6. The magnetic recording medium as claimed in claim 1,
wherein a base layer and an orientation control layer made of a non-magnetic material including nitrogen or oxygen are provided between the substrate and the recording layer;
the recording layer is made of a ferromagnetic material having a hcp structure wherein Co is a major ingredient;
the recording layer is epitaxially grown on a surface of the base layer; and
a c axis of the base layer is inclined against the substrate surface.

7. The magnetic recording medium as claimed in claim 6,
wherein an anodic oxidation aluminum film having a plurality of pores is provided on the substrate or the base layer; and
the recording cell is made of the recording layer filling in the pore.

8. The magnetic recording medium as claimed in claim 7,
wherein an oblique angle of the c axis against the substrate surface is larger than 0 degrees and equal to or less than 30 degrees.

9. The magnetic recording medium as claimed in claim 1,
wherein the recording layer includes a hard magnetic nano particle;
a major ingredient of the hard magnetic nano particle is an alloy of a compound selected from the group consisting of FePt, FePd and CoPt; and
a magnetic easy axis of the hard magnetic nano particle is inclined against the substrate surface.

10. The magnetic recording medium as claimed in claim 1,
wherein an average oblique angle of the c axis or the magnetic easy axis of the recording layer against the substrate surface is equal to or larger than 10 degrees and equal to or less than 80 degrees.

11. The magnetic recording medium as claimed in claim 1,
wherein an element parallel with the substrate surface of a c axis or a magnetic easy axis of the recording layer is orientated in a direction against the recording direction in a range between 0 degrees and ±45 degrees.

12. The magnetic recording medium as claimed in claim 1,
wherein an element parallel with a substrate surface of a c axis or a magnetic easy axis of the recording layer is substantially parallel with the track width direction.

13. The magnetic recording medium as claimed in claim 1, further comprising:
a soft magnetic lining layer provided on the substrate.

14. A magnetic storage apparatus, comprising:
a recording generation part having a magnetic head; and
a magnetic recording medium including a plurality of recording cells separated from each other on a substrate in a recording direction and a track width direction perpendicular to the recording direction;
wherein the recording cell includes a recording layer; and
the recording layer has a magnetic easy axis inclining in a designated oblique direction against a surface of the substrate.

15. The magnetic storage apparatus as claimed in claim 14,
wherein the magnetic head includes a recording element having a magnetic monopole type main magnetic pole.
